(19) United States
(12) Patent Application Publication
(10) Pub. No.: US 2009/0199171 A1
(43) Pub. Date: Aug. 6, 2009

(54) Code Size Reduction by Outlining Specific Functions in a Library

(75) Inventors: John Roe, Cambridge (GB); Howard Price, Buckinghamshire (GB); Toby Gray, Cambridge (GB)

Correspondence Address: Saul Ewing LLP (Philadelphia), Attn: Patent Docket Clerk, 2 North Second St., Harrisburg, PA, 17101, US

(73) Assignee: Nokia Corporation

(21) Appl. No.: 12/281,100

(22) PCT Filed: Mar. 1, 2007
(86) PCT No.: PCT/GB2007/000710

§ 371 Date: Mar. 1, 2009

(30) Foreign Application Priority Data
Mar. 1, 2006 (DE) 0604136.2
Apr. 7, 2006 (GB) 0607068.4
Dec. 20, 2006 (GB) 0625409.8

(51) Int. Cl. G06F 9/45

(52) U.S. Cl. 717/163

(57) ABSTRACT

A method of reducing the size of a set of computer code intended for use in a computing device, the set of code being intended for loading into memory automatically when the computing device is powered up, and comprising functions for performing computing tasks, the method comprising: specifying a particular use of the computing device; identifying those functions in the set of computer code that will be required in order to implement the said use of the computing device; and removing the identified functions from the set of code and placing them in a separate computer code library.

This invention relates to a method of reducing the size of a set of computer code, and to a method of creating a library of computer code.

The term computing device as used herein is to be expansively construed to cover any form of electrical computing device and includes, data recording devices, computers of any type or form, including hand held and personal computers such as Personal Digital Assistants (PDAs), and communication devices of any form factor, including mobile phones, smart phones, communicators which combine communications, image recording and/or playback, and computing functionality within a single device, and other forms of wireless and wired information devices, including digital cameras, MP3 and other music players, and digital radios.

Modern computing devices generally contain multiple types of memory. Memory can be broadly categorised into two types:
1. Memory that can be used for programs that execute In Place (XIP), that is where the programs do not need to be loaded into a different form of memory in order to execute. The various types of RAM (Random Access Memory) are the most prominent examples of this type. However, because RAM is volatile and loses its contents when powered down, many devices include smaller amounts of the more expensive but slower varieties of non-volatile XIP memory such as NOR Flash.
2. Memory that can be used for storage, but not for XIP; generally this is because it can only be accessed sequentially or in blocks, rather than being randomly addressable. Disk drives and NAND Flash are prominent examples of this type. Programs kept in storage memory have to be copied to XIP memory in order to be able to run.

There is additionally one significant difference between these two types of memory; XIP memory is much more expensive than memory which can only be used for storage. Because there are considerable cost pressures on the manufacture of modern computing devices, including portable devices such as mobile telephones which are aimed at the price sensitive mass market, it is desirable that such devices should wherever possible minimise their requirements for XIP memory.

It is known that there is a requirement for computing devices to be provided with software that is essential to the proper functioning of the device in some type of permanent non-volatile storage as part of the manufacturing process. Such software commonly includes data and programs that are necessary to the boot-up procedures that run when the device is powered up, or that provide Operating System (OS) services that are required frequently, or that provide critical applications.

Devices that keep as much as possible of this type of software in storage memory, copying it to XIP memory (loading it) when needed and releasing the XIP memory when no longer needed (unloading it), are able to minimise their manufacturing costs compared to devices that keep more of this software in XIP memory.

More specifically, where the core OS of a device has been provided in storage memory at manufacture time, it generally needs to be copied as an entire OS image from storage to XIP memory as part of the startup (boot) process. The term “core OS” is used here in a general sense to refer to the parts of an OS that are essential to the basic operation of a computing device, and that are therefore loaded automatically when the computing device is powered up. An “OS image” is a file representing the entirety of the OS software. The size of an OS image is thus the footprint of the OS when stored in memory.

In general, once loaded into XIP memory an OS image cannot be practically unloaded, even in part; it is known to those skilled in the art that because such OS images are typically built using a technique known as static linkage, the memory locations they occupy must be regarded as reserved and are not available for reuse by other software.

A device that minimises the size of the core operating system will be able to minimise the fixed cost of providing XIP memory dedicated for its use, thus minimising the requirements of the device for XIP memory and making it less expensive to buy and more accessible to the general public. It also provides the benefits that less storage memory is required to store the core OS, that the device will boot up quicker, since less data needs to be copied from storage memory to XIP memory, and that power consumption will probably be lower, since using less XIP memory in the form of dynamic RAM will reduce overall power consumption.

Where manufacturers of computing devices provide such devices as families of products, with each member of a family exhibiting different functionality but being developed from the same or similar software, it is desirable from a device manufacturer's perspective for all the members of a family of products to include compatible core operating systems. It is known that this both decreases the manufacturer's development costs and increases reliability of the device.

Furthermore, where such devices are open and permit the post-manufacture installation of software modules and programs providing additional functionality, the provision of compatible core operating systems across an entire family enables such modules and programs to be targeted at a much larger number of devices. The resulting economies of scale can lower development costs and increase reliability for third party manufacturers.

Finally, there are additional benefits for the end-users of these computing devices. As well as benefiting from lower prices and better products, enabling the utilisation of such software modules across an entire family of products considerably reduces the complexity involved in obtaining and installing after-market software. Instead of specifying the exact model of computing device they posses, it is sufficient to simply specify the family that their device belongs to, in the secure knowledge that all the devices in that family are compatible with each other.

The related members of product families are typically differentiated by feature sets, which enables specific models to be are aimed at different segments of the market.

This is especially true of multi-functional computing devices, such as mobile cellular telephones. It is known that these are exhibiting a phenomenon known as convergence, whereby functionality that was previously embodied in separate devices becomes available in a single device. For example, the ten items of functionality previously separately available in the digital music player, the digital camera, the FM radio, the PDA, the pager, the alarm clock, the electronic messager (such as the RIM Blackberry), the dictating machine, the portable games console, and the mobile phone can all be found in a single currently available computing devices such as the Sony Ericsson P910i. However, it is also known that the complexity of converged devices can often be a deterrent to their effective use, and that the necessary compromises needed to provide all functionality on a single device and in a single form factor can lead to a less than satisfactory user experience.

This is one reason why differentiation by feature set is becoming increasingly common in computing devices. Taking the mobile phone again as an example, it is now possible for a customer to choose between devices that are designed for digital music (with storage memory, good headphones, and buttons designed for music playing), or for digital photography (with storage memory and superior lenses), or for electronic messaging (with proper QWERTY keyboards), or for games playing (with special thumb buttons); many other specialised feature sets are currently available, and the years to come will no doubt see many more.

A related reason for specifying a particular feature set is to enable segmentation according to price, with more expensive features removed in order to provide devices at the lower price end of the product family.

Manufacturers therefore are increasingly bringing out product ranges that belong to the same device family, but are differentiated in terms of their feature set.

The problem that needs to be solved here is that there is no obvious way of reconciling all of the following three requirements:
1. Minimising the size of the core OS image, which makes the devices less expensive, faster to boot, and consume less power.
2. Maintaining compatibility across all models belonging to the same device family, which brings the economies of scale that both reduce software development costs and increase software reliability.
3. Differentiating devices in the same device family so that they satisfy the varying needs of different sets of users.

It is apparent that where computing devices are differentiated, the items that need to be included in the core OS image for each model in the family are going to different. Taking as three specific applications a music playlist editor and selector, a camera and movie application and an 802.11 wireless networking driver, it can be easily seen that the requirements of the music player device, the digital camera devices and the messaging devices are incompatible. For all three, what is an essential feature for one device, that has to be part of the core OS image, is of marginal use to the other two. If the marginal features could be eliminated from the core OS image, each of the three differentiated devices would be less expensive and faster to manufacture, would boot up quicker, and would consume less power.

But simply eliminating the marginal features on differentiated converged devices would make devices incompatible and would therefore destroy most of value inherent in the concept of a family of models. The main reason for the incompatibility was described above; the core OS image is built using static linkage, and after-market software expects specific functionality to be available via specific locations in that image for all models in the same family. Consequently, existing families of computing devices which copy the core OS image from storage to XIP memory have to include support for non-essential or seldom used features in order to maintain compatibility. This bloats the operating system and adds to manufacturing costs without contributing any other value. It also increase startup time, as the support code for these features needs to be copied from storage to XIP memory even though it will not be frequently used, and it also increases power consumption where the XIP memory is dynamic RAM.

While it is of course possible to manufacture an alternative version of the core operating system without these less frequently used portions, such a version would necessarily abandon a number of the considerable economic benefits to both the manufacturer and their customers of maintaining a coherent product family:
1. Such a version of the core OS would not benefit from compatibility with the original, full, version. In particular, any software installed post-manufacture that relied on code that was supposed to reside in the fully featured version of the core OS would fail to work.
2. Because an alternative version of the OS would fragment the product family, it would require separate development and testing, thereby increasing development costs and time to market.

According to a first aspect of the present invention there is provided a method of reducing the size of a set of computer code intended for use in a computing device, the set of code being intended for loading into memory automatically when the computing device is powered up, and comprising functions for performing computing tasks, the method comprising: specifying a particular use of the computing device; identifying those functions in the set of computer code that will be required in order to implement the said use of the computing device; and removing the identified functions from the set of code and placing them in a separate computer code library.

The step of removing the identified functions could comprise replacing the identified functions with code arranged to call the separate computer code library, whereby the combined functionality of the reduced set of computer code and the separate computer code library is equivalent to the functionality of the original set of code.

The step of identifying the required functions may comprise: executing the original set of computer code to perform the said use on a test computing device; and determining which functions in the set of computer code are used during the execution.

The step of determining which functions in the set of computer code are used during the execution could involve the use of function profiling or callgraph analysis techniques.

The particular use of the computing device could represent an application expected to be used infrequently in the computing device, and/or it could represent an application that is not essential to the operation of the device.

The separate computer code library may be a dynamic link library.

The step of placing the identified functions in a separate computer code library could result in a library in which functions are clustered according to a corresponding use of an associated computing device.

The set of computer code is preferably executable code.

According to a second aspect of the invention there is provided a reduced set of computer code obtained from the method described above.

According to a third aspect of the invention there is provided an operating system comprising the reduced set of computer code obtained from the method described above.

The operating system could further comprise the separate computer code library.

According to a fourth aspect of the present invention there is provided a computing device comprising the reduced set of computer code obtained from the method described above.

The computing device could further comprise the separate computer code library.

The reduced set of computer code and the separate computer code library could be parts of an operating system of the computing device. The separate computer code library is preferably loadable into memory of the device separately from the reduced set of computer code.

According to a fifth aspect of the invention there is provided a method for creating a library of computer code intended for use on a computing device, the method comprising: specifying a particular use of the computing device; identifying a set of functions for performing computing tasks, the set of functions being required to implement the said use of the computing device; and placing the set of functions in a library, such that the functions in the library are grouped according to a use of the computing device, and not according to the computing tasks performed by the individual members of the set.

According to a sixth aspect of the invention there is provided a dynamic link library comprising a set of functions for performing computer tasks, wherein each function in the set is required for an associated computing device to implement a particular use.

The term library is used in the present discussion to refer to a group of computer code that can be accessed from another set of code.

In some embodiments, the present invention can thus provide a method of reducing the XIP or RAM memory to take account of differentiation in feature sets, while at the same time maintaining compatibility between all members of a product family irrespective of the features they offer.

The preferred implementation of this idea provides a mechanism for saving XIP or RAM memory on devices which provide their core operating system together with other (non-core) executables in NAND flash storage memory.

The core OS image typically contains executable files together with all their dependencies and is recursively copied from NAND Flash to RAM at boot. This core OS image is supplied as a single file on NAND flash; when the image is copied into RAM, it then appears as multiple files in a conventional XIP read-only file system (ROFS). The remainder of the non-core executables remain in the non-XIP ROFS on NAND flash and are loaded and unloaded on demand; unlike the contents of the core image, they don't have to occupy reserved sections of memory, and any resources they consume can be freed when they are no longer required.

As described above, provision of identical fully-featured versions of the core OS on devices with differentiated feature sets would inevitably allocate valuable and scarce XIP memory at boot time for features actually are not all core to the operation of the device. Furthermore, because the entire core is statically linked, it is impractical for the RAM so allocated to be freed up for other purposes.

The methods disclosed herein can reduce this memory overhead while retaining compatibility with fully featured core OS devices.

It should be appreciated that functionality can be provided in a computing device in two different forms. One type of executable file (commonly known as an EXE in many operating systems) provides a single application, with a single entry point, and typically contains functionality that is not to be shared with other applications. Removal of this type of stand-alone executable from a core OS image generally does not lead to compatibility problems, because it does not provide shared functionality that is accessible by calling to a specific internal memory location.

In contrast, multiple areas of shared functionality are provided by a different type of executable file, commonly referred to as a Dynamically Linked Library (DLL). This type of executable both provides a way by which functionality can be provided in modular format and also help reduce memory overhead, because a DLL can be concurrently shared by multiple applications that require the same functionality. Unlike the other type of executable providing a single application, which are generally executed from a single entry point at their beginning, a DLL is provides with multiple entry points, each of which normally provides different functionality.

It should be noted that there are two main ways of identifying these entry points into a DLL. The first option is to refer to the entry points by name. The second option is to refer to the entry points by ordinal number. This latter option is frequently referred to as function ordinal mapping or function ordinal linking.

Because names are potentially long in comparison to ordinals, require additional code for their definition, and because it takes much longer to locate a function by matching its name than to locate its ordinal position, their use of names is generally considered to be wasteful of the memory and other resources of the computing device in comparison to the use of ordinal numbers.

Ordinal linking of the access points is therefore the preferred implementation, especially for operating systems that are resource aware, particularly in those designed for small, portable, battery-powered resource-constrained devices which have very restricted physical resources in comparison to those available in desktop or portable PC devices. For such devices, the efficient use of code is of paramount importance; mobile telephones are one example of this type of computing device. The description of this invention is in terms of ordinal linking; however, this is not intended to limit the applicability of the invention in any way.

The insight underlying this invention is that it is possible, for the shared functionality provided in the DLLs of any differentiated computing device which derives from an operating system common to an entire family, to split of a single statically loaded original DLL into one smaller statically loaded host DLL and one or more dynamically loaded helper DLLs.

The invention will now be described by way of example with reference to the accompanying drawings, in which:

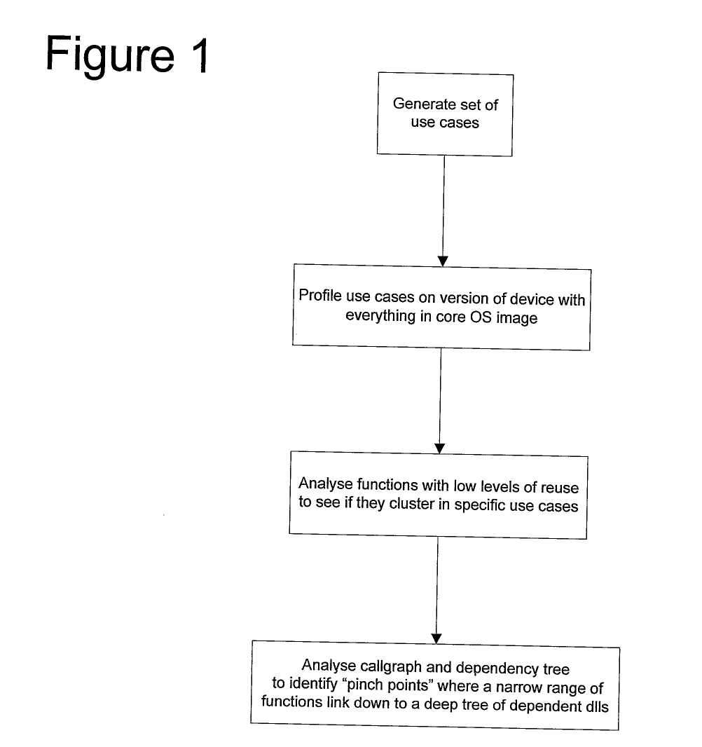

FIG. 1 is a flow chart illustrating the analysis of a set of functions;

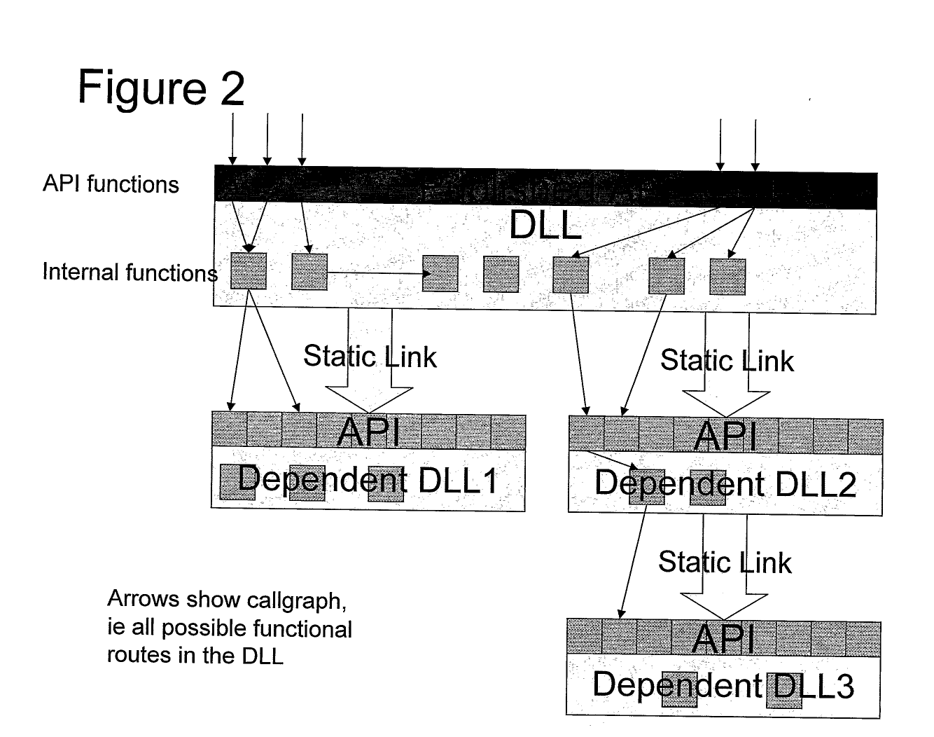

FIGS. 2-7 illustrate some code analysis techniques that can be used in accordance with the invention.

The following embodiments show how an optimal splitting of an original DLL can be achieved, and how considerable XIP memory can thereby be saved by breaking complex static dependency chains. We describe how the new host DLL remains completely binary compatible with the old one, but will dynamically load functionality on demand. If the host DLL is called upon to provide some functionality which has been split off, it loads the appropriate helper DLL in order to fulfil the request. Subsequently, when the helper DLL is no longer required, it can be unloaded, and its memory freed.

### Splitting an Original DLL

The first step in determining how to split a set of original DLLs for any particular differentiated device to generated a set of use cases for the typical use of that device. This is a technique well known to those skilled in the art. It should be noted that the fact that the device under consideration is differentiated from others in the family means that the generation of distinctive use cases is relatively straightforward.

The second step is to build a generic test operating system for the device family using the original DLLs, and then to profile all the function paths in the DLL which are executed in the use cases derived in the previous step. Subsequent analysis of this data enables us to determine those groups of functions used in none, one, or very few use cases. Those functions which have high level of reuse across different use cases are likely to stay in the host (static) DLL, while those functions which have low level of reuse across different use case are likely to stay in a helper (dynamic) DLL. It should be noted that the use case of the computing device booting up is to be regarded as a special one; a function executed when the device is booting up would be kept in the host DLL even if this were the only use case in which it appeared.

The third step is to analyse the functions with a low level of reuse to see if they cluster around specific use cases. Where they do, there is a clear case for generating multiple helper DLLs, as this will be a quicker and more efficient method of loading the required functionality than having a single helper DLL.

It should be noted that in this embodiment, each helper DLL is aligned along use-cases rather than being functionally aligned. This can be contrasted with classic DLL design, which tends to group all related functionality into a single DLL for convenience irrespective of the level of use. For example, it is common to group all mathematical functions into a single maths DLL. By means of this embodiment, the grouping would become far more user-centric; so if booting the phone requires cosine functions and running an application requires tangent functions, it is likely that these would now be placed in separate DLLs even though conventional design thinking would put them together.

The fourth and final step in assessing which functions to move into helper DLLs is to iteratively analyse the call graph underlying the functions assigned to host DLLs. The bigger the call graph beneath a function, the more dependencies it has, and the bigger the saving that can be obtained by moving it into a helper. It should be noted that this step can provide the greatest benefit, as it has the capability to break down static dependency chains. The quest is to find points where a narrow range of functions link down to a deep tree of dependent dlls—such points are known as pinch points. This can be done manually or automatically via a mathematical process which permutates the possible combinations of function groups to find the optimum split for helper DLLs. When pinch points are identified, the function or functions at the top of the dependency tree, together with all functions that are called by the ones at the top, may be moved to one or more separate libraries.

The above steps are shown diagrammatically in FIG. 1.

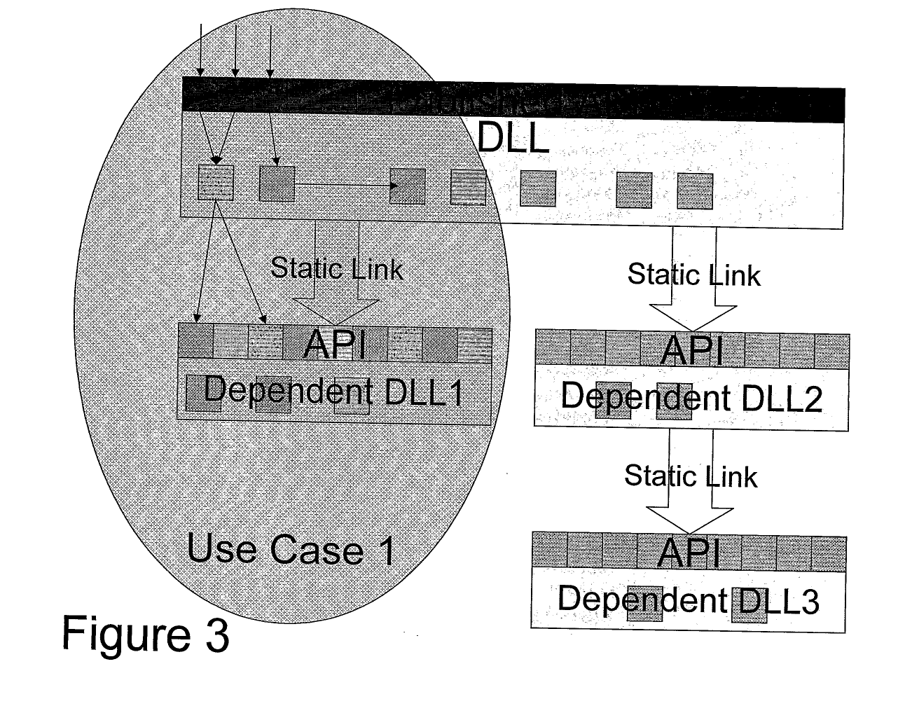

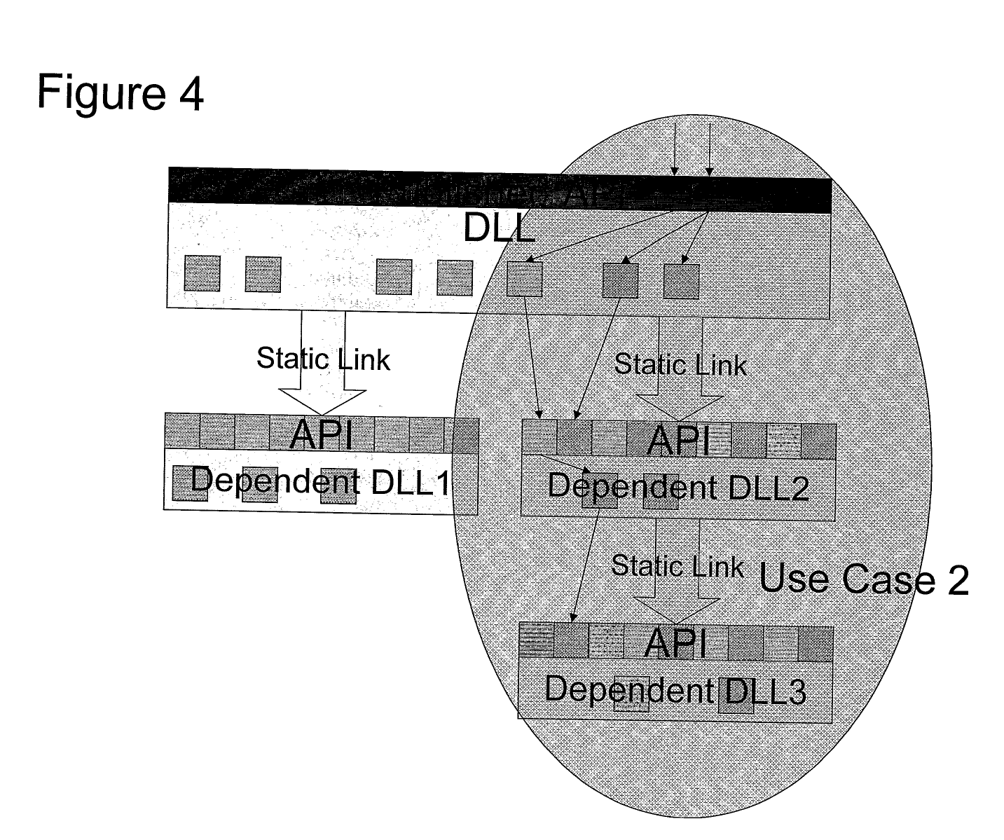

The remaining figures illustrate the final two steps. FIG. 2 shows the type of information that can be gathered from the profiling and callgraph analysis, and how the dependencies between functions and methods of different DLLs can be isolated. FIGS. 3 and 4 show how these dependencies might cluster into two different use cases.

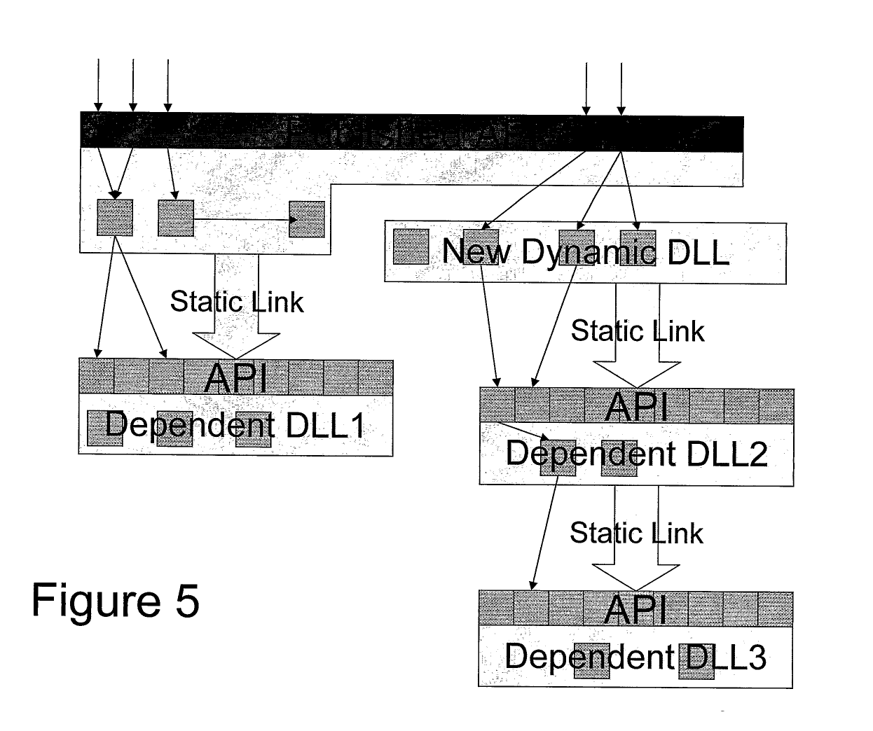

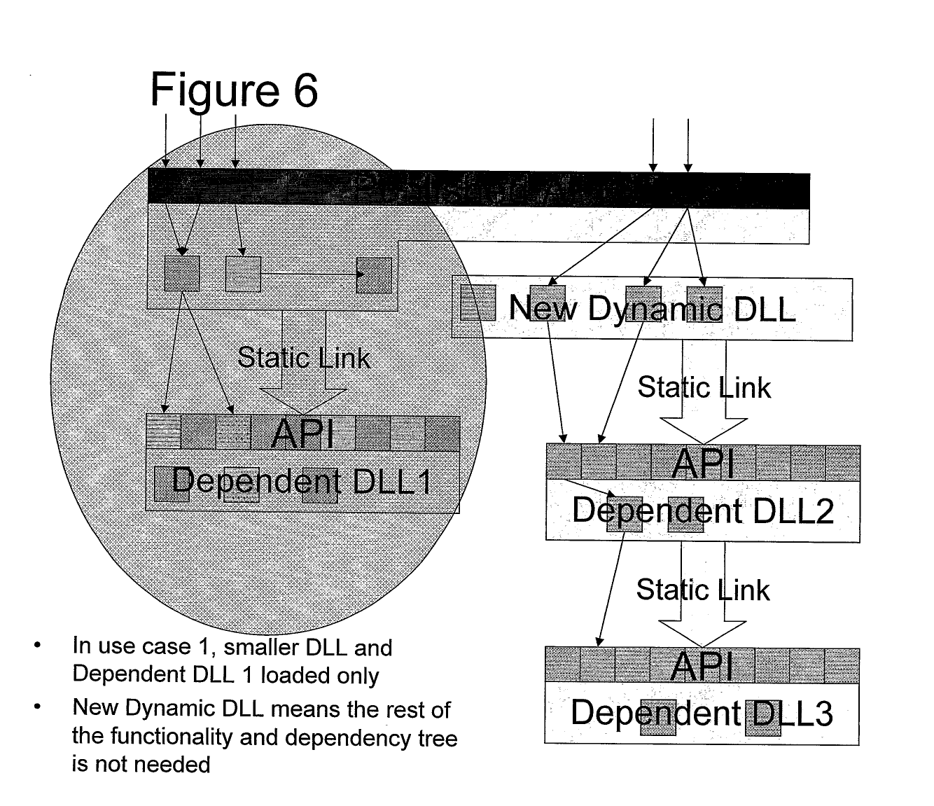

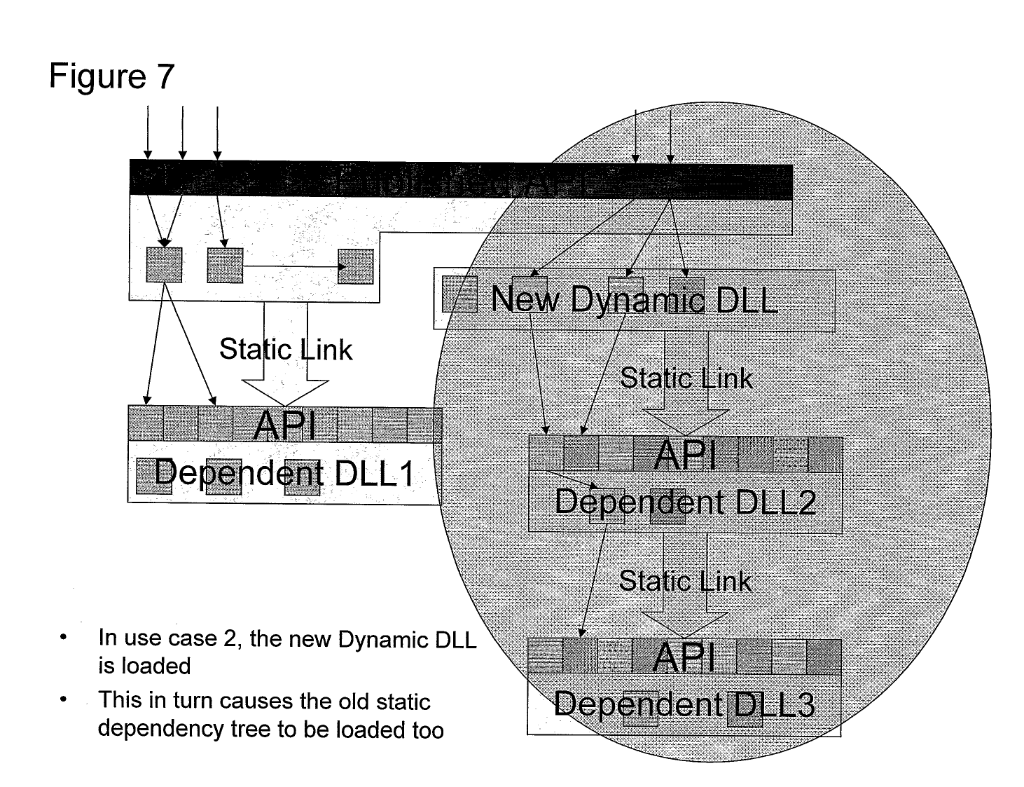

Use case 1 as shown in FIGS. 2, 3 and 4 is the special one of the device booting up; therefore the methods and functions it uses with all their dependencies remain in the core OS image and continue to be statically linked. Use case 2, on the other hand, is one that is initiated either by the user of the device, or is triggered by a particular external event. The methods and functions it uses can be moved to a new dynamically loaded DLL; where its dependent DLLs are not needed by other use cases, they too can be loaded dynamically. FIG. 5 shows the split suggested by the analysis, FIG. 6 shows use case 1 in more detail, and FIG. 7 shows use case 2 in more detail.

Passing Calls from Host DLL to Helper DLL

The mechanism for this would normally be added at the same time as the generation of the host DLL from the original DLL. The host DLL would replace those functions that have been delegated to helper DLLs with stub code. By stub code we mean code that does not perform any processing that fulfils the original request. In this case, all the stub code does is to pass the call through to the appropriate function in the appropriate helper DLL. This method enables an original DLL to be split into a host DLL and multiple helper DLLs.

### Loading Helper DLLs

There are a number of ways of loading the helper DLLs.
a) The helper DLL can be loaded on request for any of its functions. This is transparent to any caller; the host DLL remains is binary compatible with the original DLL. The code for loading the helper DLL (if necessary) would be included in the stub code generated at the same time as the host DLL.
b) The helper DLL can be loaded proactively via a direct request by an application or client, once it had reached a point where the need for the availability of appropriate functionality became apparent. This mechanism has the disadvantage that the application or client would need to be modified, requiring different versions for different devices in the same family.
c) The helper DLL can be loaded proactively provided that the use case analysis revealed a pattern that could be used to spot when the appropriate functionality was needed, or that a use case requiring it had begun. This would be transparent to the application or client. For instance, if we knew that function “y” was always called just before the group of functions required for use case “b”, then we can start loading up the right helper for use case “b” asynchronously so it's ready when we need it. The trigger for this could be included in the code for function “y” when the host DLL was generated. This mechanism has the advantage that helper DLLs required by more than one host DLL could be linked to the same use case; so once the use case has been identified it could trigger all the right helpers DLLs for multiple host DLLs. A variant of this mechanism would be for function “y” to make use of a system-wide notification mechanism (for example, a publish and subscribe server) which would trigger the appropriate loads. The code for loading the helper DLL could be added to the stub function that had been identified by the analysis.

### Unloading Helper DLLs

After a helper DLL has been used, and when it is no longer needed, it can be unloaded and the memory it occupies can be released for other uses. There are a number of possible mechanisms for unloading helper DLLs
a) The helper DLL can be unloaded proactively via a direct request by an application or client, once it had reached a point where it was apparent that the availability of appropriate functionality was no longer required. This mechanism has the disadvantage that the application or client would need to be modified, requiring different versions for different devices in the same family.
b) The helper DLL can be unloaded proactively provided that the use case analysis revealed a pattern that could be used to spot when the appropriate functionality was no longer needed, or that a use case requiring it had ended. This would be transparent to the application or client. For instance, if we knew that the group of functions required for use case “b” were no longer called after function “y”, then we could unloading the helper for use case “b” immediately after function “y”. The trigger for this could be included in the code for function “y” when the host DLL was generated. This mechanism has the advantage that helper DLLs required by more than one host DLL could be linked to the same use case; so once the use case has been identified it could trigger unloading multiple helpers DLLs for multiple host DLLs. The code for unloading the helper DLL could be added to an appropriate stub function that had been identified by the analysis. A variant of this mechanism would be for function “y” to make use of a system-wide notification mechanism (for example, a publish and subscribe server) which would trigger the appropriate unloading.
c) The helper DLL could be unloaded after a period of time during which none of its functions were called; this mechanism is somewhat analogous to the least frequently used algorithms employed in connection with memory paging.

It has been explained above how the RAM requirements of differently featured models of computing devices belonging to the same family can be matched to the feature level of each particular models while retaining compatibility with other models in the same family. Implementations of this concept may be particularly suitable for those devices where a core operating system image is provided in NAND flash or other types of non-executable non-volatile storage memory, and where that image is copied into RAM at boot. A preferred implementation includes identifying functionality that is less often used by a differentiated device by generate use cases for that device, and then profiling the functions called by those use cases on a fully-featured member of the device family. Analysis of the resulting call graphs reveals which functions need to remain as host DLLs in the core OS image and which can reasonably be loaded dynamically from helper DLLs. Binary compatibility with the device family is maintained by replacing those functions removed to the helper DLL from the host DLL with stubs that pass calls and requests through to the helper DLL.

It can be seen from the specific examples discussed above that various advantages can result from using embodiments of the present invention. Some potential advantages are:
The size of an OS core image in a NAND flash computing device belonging a family of such devices can be tailored to the functionality required by that device, while retaining binary compatibility with other devices in the same family which are fully featured.
The smaller size of the core OS image in NAND flash means that the image consumes less RAM once loaded.
The smaller size of the core OS image in NAND flash means that the device will boot up faster.
The fact that less RAM is required means that devices with a reduced feature set are able to be manufactured for a lower cost and a smaller use of natural resources.
The fact that less RAM is required means that device with a reduced feature set will consume less power.

It will be understood by the skilled person that alternative implementations are possible, and that various modifications of the methods and implementations described above may be made within the scope of the invention, as defined by the appended claims.

1. A method of reducing the size of a set of computer code intended for use in a computing device, the set of code being intended for loading into memory automatically when the computing device is powered up, and comprising functions for performing computing tasks, the method comprising:
specifying a particular use of the computing device;
identifying those functions in the set of computer code that will be required in order to implement the said use of the computing device; and
removing the identified functions from the set of code and placing them in a separate computer code library.

2. A method according to claim 1 wherein the step of removing the identified functions comprises replacing the identified functions with code arranged to call the separate computer code library, whereby the combined functionality of the reduced set of computer code and the separate computer code library is equivalent to the functionality of the original set of code.

3. A method according to claim 1 wherein the step of identifying the required functions comprises:
executing the original set of computer code to perform the said use on a test computing device; and
determining which functions in the set of computer code are used during the execution.

4. A method according to claim 3 wherein the step of determining which functions in the set of computer code are used during the execution involves the use of function profiling or callgraph analysis techniques.

5. A method according to claim 1 wherein the said use of the computing device represents an application expected to be used infrequently in the computing device.

6. A method according to claim 1 wherein the said use of the computing device represents an application that is not essential to the operation of the device.

7. A method according to claim 1 wherein the separate computer code library is a dynamic link library.

8. A method according to claim 1 wherein the step of placing the identified functions in a separate computer code library results in a library in which functions are clustered according to a corresponding use of an associated computing device.

9. A method according to claim 1 wherein the set of computer code is executable code.

10. A reduced set of computer code obtained from the method of claim 1.

11. An operating system comprising the reduced set of computer code obtained from the method of any of claim 1.

12. An operating system according to claim 11 further comprising the separate computer code library of claim 1.

13. A computing device comprising the reduced set of computer code obtained from the method of claim 1.

14. A computing device according to claim 13 further comprising the separate computer code library of claim 1.

15. A computing device according to claim 14 wherein the reduced set of computer code and the separate computer code library are parts of an operating system of the computing device.

16. A computing device according to claim 14 wherein the separate computer code library is loadable into memory of the device separately from the reduced set of computer code.

17. A method for creating a library of computer code intended for use on a computing device, the method comprising:
specifying a particular use of the computing device;
identifying a set of functions for performing computing tasks, the set of functions being required to implement the said use of the computing device; and
placing the set of functions in a library, such that the functions in the library are grouped according to a use of the computing device, and not according to the computing tasks performed by the individual members of the set.

18. A dynamic link library comprising a set of functions for performing computer tasks, wherein each function in the set is required for an associated computing device to implement a particular use.
